(19) United States
(12) Patent Application Publication
(10) Pub. No.: US 2003/0005943 A1
(43) Pub. Date: Jan. 9, 2003

(54) High pressure wafer-less auto clean for etch applications

(75) Inventors: Harmeet Singh, Berkeley, CA (US); John E. Daugherty, Newark, CA (US); Saurabh J. Ullal, Berkeley, CA (US)

Correspondence Address: MARTINE & PENILLA, LLP, 710 LAKEWAY DRIVE, SUITE 170, SUNNYVALE, CA, 94085, US

(73) Assignee: LAM RESEARCH CORPORATION, Fremont, CA

(21) Appl. No.: 10/138,288

(22) Filed: May 2, 2002

Related U.S. Application Data
(60) Provisional application No. 60/288,681, filed on May 4, 2001.

(51) Int. Cl. B08B 6/00; C25F 1/00

(52) U.S. Cl. 134/1.1; 134/18; 438/905

(57) ABSTRACT

A method for cleaning a processing chamber is provided. The method initiates with introducing a fluorine containing gaseous mixture into a processing chamber. Then, a plasma is created from the fluorine containing gaseous mixture in the processing chamber. Next, a chamber pressure is established that corresponds to a threshold ion energy in which ions of the plasma clean inner surfaces of the processing chamber without leaving a residue. A method for substantially eliminating residual aluminum fluoride particles deposited by an in-situ cleaning process for a semiconductor processing chamber and a plasma processing system for executing an in-situ cleaning process are also provided.

### CROSS REFERENCE TO RELATED APPLICATIONS

This application is related to (1) U.S. patent application No. ______ (Attorney Docket No. LAM2P285), filed on May 3, 2002, and entitled “Endpoint Determination of Process Residues in Wafer-less Auto Clean Process Using Optical Emission Spectroscopy,” (2) U.S. patent application No. ______ (Attorney Docket No. LAM2P286), filed May 3, 2002, and entitled “Plasma Cleaning of Deposition Chamber Residues Using Two Step Wafer-less Auto Clean Method,” These applications are hereby incorporated by reference.

### FIELD OF THE INVENTION

This invention generally relates to an apparatus and method of cleaning a processing chamber to remove previously deposited chamber residues, which have accumulated on interior surfaces of the apparatus. In particular, the invention relates to a high pressure wafer-less plasma cleaning method for the elimination of residues on interior walls of the processing chamber.

### BACKGROUND OF THE INVENTION

The continuing trend for smaller geometries for semiconductor devices makes it more difficult to maintain the uniformity and accuracy of critical dimensions. Moreover, it has become increasingly important that the environment inside the processing chamber be clean and consistent to ensure acceptable wafer to wafer variability of the critical dimensions. As is known in the art, many of the processes carried out within the semiconductor processing chambers leave deposits on the inner surfaces of the processing chamber. As these deposits accumulate over time, they can become a source of particulate contamination that is harmful to the substrates being processed should the particulate contamination flake off and fall onto the surface of the substrate.

In addition, the build up of deposits on the inner surfaces of the chamber causes an inconsistent environment which impacts the processing operation being performed. That is, the build up of deposits increases with each processing operation. Thus, each successive processing operation does not initiate with the same chamber conditions. Accordingly, the changed starting conditions for each successive processing operation causes a variance that eventually exceeds acceptable limits, which results in etch rate drift, critical dimension drift, profile drift, etc.

One attempt to solve these issues has been to run in-situ cleaning processes in between processing operations. However, these cleaning processes tend to leave residues of their own behind. Thus, as a result of attempting to clean the processing chamber of one contaminant, the cleaning process leaves behind another residue that may build up over time and eventually flake off onto a semiconductor substrate. In addition, failure to completely clean the etch chamber effects the processing of the next semiconductor substrate. That is, the reproducibility and repeatability of the etch rate from wafer to wafer is gradually impacted such that the processing chamber will have to be wet cleaned in order to perform processing within acceptable limits. Thus, the system throughput is adversely impacted because of the restricted mean time between wet cleans.

FIG. 1A is a simplified cross-sectional view of an etch chamber. Etch chamber 100 includes RF coil 102 disposed over window 104. Window 104 has a bottom surface 104a and a top surface 104b. A semiconductor substrate 106 to be processed rests on substrate support 108. In between each process operation, a wafer-less auto clean (WAC) process can be performed in order to minimize buildup of residues on the inner surface of etch chamber 100. However, it has been observed that the WAC process itself leaves a thin ring of dust, i.e., particulates or residues, on the bottom surface 104a of window 104. FIG. 1B is a bottom view of window 104 of FIG. 1A. Here, the ring of dust is defined along the circumference of window 104. As more residue accumulates on window 104, the impact on the processing operation, such as an etch operation, becomes more severe because of the residue buildup on the window. Additionally, the residue on window 104 increases the variability of the etch operation from wafer to wafer to an unacceptably high level.

In view of the foregoing, what is needed is a method and apparatus for in-situ cleaning of a process chamber that does not leave any residue, thereby extending the mean time between wet cleans.

### SUMMARY OF THE INVENTION

The present invention provides a method and apparatus for providing a wafer-less auto clean process that is substantially residue free. It should be appreciated that the present invention can be implemented in numerous ways, including as an apparatus, a system, a device, or a method. Several inventive embodiments of the present invention are described below.

In one embodiment, a method for cleaning a processing chamber is provided. The method initiates with introducing a fluorine containing gaseous mixture into a processing chamber. Then, a plasma is created from the fluorine containing gaseous mixture in the processing chamber. Next, a chamber pressure is established that corresponds to a threshold ion energy in which ions of the plasma clean inner surfaces of the processing chamber without leaving a residue.

In another embodiment of the present invention, a method for substantially eliminating residual aluminum fluoride particles deposited by an in-situ cleaning process for a semiconductor processing chamber formed, at least in part, from aluminum, is provided. The method initiates with performing a processing operation on a semiconductor substrate disposed within a semiconductor processing chamber. Then, an in-situ cleaning process is initiated upon completion of the processing operation and removal of the semiconductor substrate. The initiation of the in-situ cleaning process includes flowing a fluorine containing gas into the processing chamber. Then, a pressure is established within the processing chamber where the pressure allows a plasma created from the fluorine containing gas to clean silicon byproducts deposited on an inner surface of the processing chamber without sputtering any aluminum-containing parts of the processing chamber. Next, a fluorine containing plasma is created in the processing chamber to clean the silicon byproducts.

In yet another embodiment, a plasma processing system for executing an in-situ cleaning process is provided. The plasma processing system includes an aluminum based processing chamber configured to operate at an elevated pressure during an in-situ cleaning operation to substantially eliminate the formation of aluminum fluoride during the in-situ cleaning process. The processing chamber includes a gas inlet for introducing a fluorine containing cleaning gas, the fluorine containing cleaning gas optimized to remove silicon based byproducts deposited on inner surfaces of the processing chamber, and a top electrode for creating a plasma from the fluorine containing cleaning gas to perform an in-situ cleaning process. A variable conductance meter configured to control a pressure inside the processing chamber independently of a flow rate of process gases is included. The variable conductance meter is positioned on an outlet of the processing chamber. An optical emission spectrometer (OES) for detecting an endpoint for each step of the in-situ cleaning process performed in the processing chamber is included. The OES is in communication with the processing chamber. A pumping system for evacuating the processing chamber between each step of the in-situ cleaning process is also included.

Other aspects and advantages of the invention will become apparent from the following detailed description, taken in conjunction with the accompanying drawings, illustrating by way of example the principles of the invention.

### BRIEF DESCRIPTION OF DRAWINGS

The present invention will be readily understood by the following detailed description in conjunction with the accompanying drawings, with like reference numerals designating like elements.

FIG. 1A is a simplified cross-sectional view of an etch chamber.

FIG. 1B is a bottom view of window 104 of FIG. 1A.

FIG. 2 is a graph of the energy dispersive x-ray (EDX) spectrum of the particulate material showing the particulate matter's elemental composition to be primarily AlFₓ.

FIG. 3 is a simplified cross-sectional schematic diagram of a plasma etching system configured to execute a dual step cleaning process in accordance with one embodiment of the invention.

FIG. 4 is a flowchart diagram of the method operations performed for a dual step byproduct removal wafer-less auto clean (WAC) technique in accordance with one embodiment of the invention.

FIG. 5 is a more detailed flowchart diagram of the method operation of removal of silicon byproduct of FIG. 4.

FIG. 6 is a more detailed flowchart diagram of the method operation of removal of carbon byproducts of FIG. 4.

FIG. 7 is a graph depicting the effect of the WAC process on the etch rate performance in accordance with one embodiment of the invention.

FIG. 8 is a graph of etch rate repeatability using a Polygate Release recipe where a WAC is performed after each wafer in accordance with one embodiment of the invention.

FIG. 9 is a graph comparing silicon based byproducts present on the chamber inner surfaces before and after a high pressure WAC process is performed in accordance with one embodiment of the invention.

FIG. 10 is a graph of the area under the Si-O peak of FIG. 9 as a function of the high pressure WAC time in accordance with one embodiment of the invention.

FIG. 11 is a graph of comparing silicon based byproducts and carbon based byproducts before and after a two step high pressure WAC process is performed in accordance with one embodiment of the invention.

### DETAILED DESCRIPTION OF THE PREFERRED EMBODIMENTS

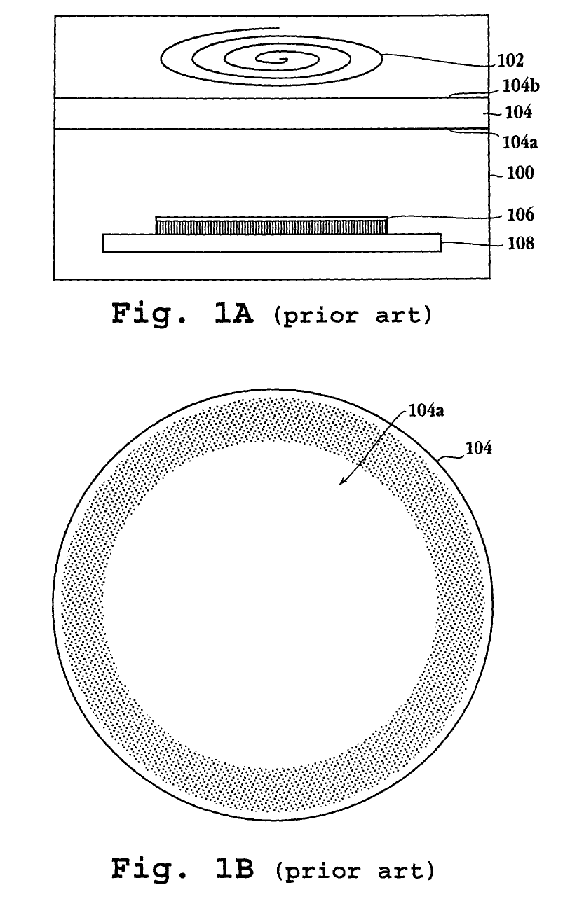

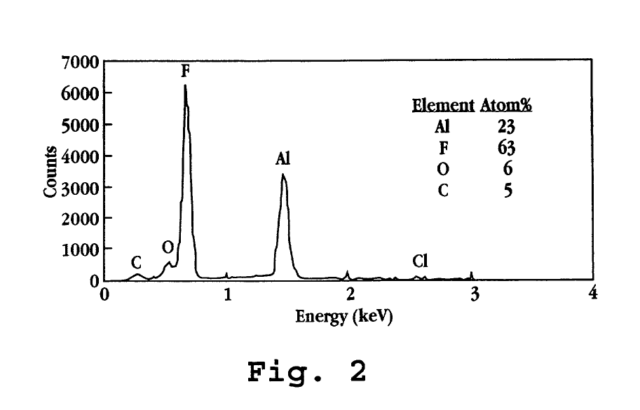

An invention is described for providing an optimized wafer-less auto clean (WAC) process that is substantially residue free, i.e., does not leave a residue related to the cleaning mechanism or cleaning gases. It will be obvious, however, to one skilled in the art, that the present invention may be practiced without some or all of these specific details. In other instances, well known process operations have not been described in detail in order not to obscure the present invention. FIGS. 1A and 1B are described in the “Background of the Invention” section.

Wafer-less auto clean (WAC) processes currently being run within processing chambers can rely on fluorine-containing plasmas for cleaning the inner surfaces of the residues from processing operations performed in the processing chamber. The WAC processes are run at low pressure, i.e., below 50 milliTorr (mT). After repeated WAC processes being run in a processing chamber, a particulate film has been observed on the window isolating the chamber from the radio frequency (RF) coils located on the top of the chamber. The particulate film is also observed on other chamber parts.

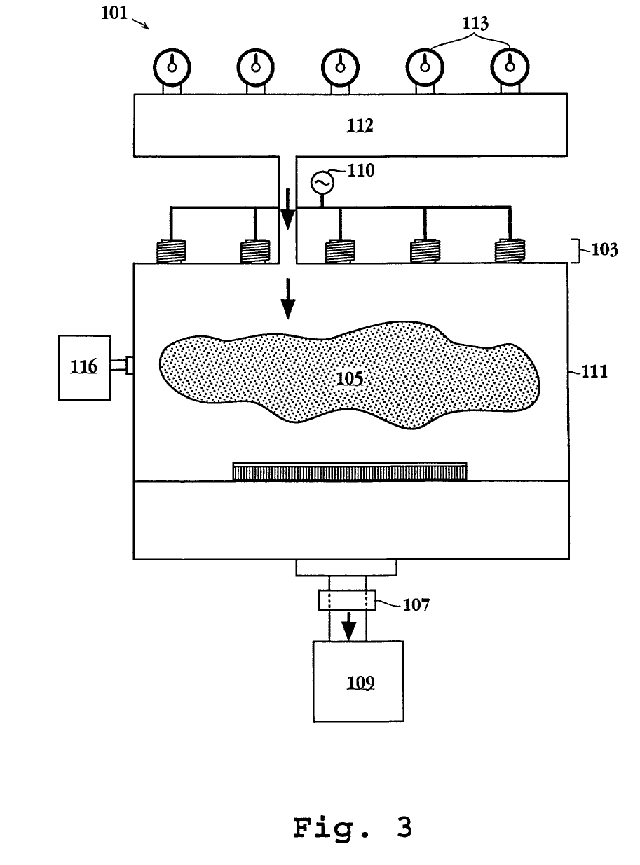

An analysis of the particulate material, which tends to appear as a brown or white dust on the window, by energy dispersive x-ray (EDX) analysis reveals that the particulate material is primarily aluminum fluoride (AlFₓ). FIG. 2 is a graph of the EDX spectrum of the particulate material showing the particulate matter's elemental composition to be primarily AlFₓ. Accordingly, the source of the AlFₓ was determined to be from the WAC. This determination was made by running WAC only cycles in the processing chamber, which resulted in the formation of the particulate film. The WAC cycles included a fluorine containing plasma. Thus, the only source of aluminum fluoride is the attack of the anodized aluminum chamber parts and aluminum-containing ceramic parts by the fluorine containing plasmas of the WAC operation with simultaneous ion-bombardment. As will be explained in more detail below, the energy of the ions can be lowered below a threshold so that the ions sufficiently clean the chamber but do not leave aluminum fluoride residues. That is, after a certain pressure level, a threshold ion energy is crossed where the energy of the ions is less aggressive on the chamber. In other words, when the threshold energy is crossed the formation of AlFₓ is substantially eliminated because the ions at the lower energy state do not attack the anodized aluminum or aluminum-containing ceramic parts from which components of the chamber are formed from. However, the silicon byproducts will still be cleaned even though the aluminum and ceramic is not effected, i.e., the aluminum and ceramic is not sputtered but the flux of the fluorine radicals incident on the chamber walls is sufficiently high enough to clean etch byproducts, such as silicon based byproducts.

The high pressure WAC can be performed as a single step process or a multiple step process. The single step WAC is directed toward silicon based byproducts deposited on the chamber surfaces. In one embodiment, a variable amount of oxygen can be added for increasing the effectiveness of the cleaning of carbon based byproducts. In another embodiment a two step high pressure WAC process can be performed where the first step is directed toward removing silicon based byproducts and the second step is directed towards removing carbon based byproducts. Described below are exemplary single step and dual step high pressure WAC processes where the pressure induces the crossing of a threshold ion energy and flux at the chamber walls such that a sufficient amount of radical flux is incident on the chamber walls to clean the deposited byproducts. However, the ion energy is insufficient to leave a residue of AlFₓ on the chamber surfaces. One skilled in the art will appreciate that additional techniques to lower the ion energy below a threshold value, such as adding gases with large ionization cross-sections (e.g., Ar, Kr, Xe), can be used also.

Knowledge about the potential distribution in plasma etching systems is useful because the energy with which particles impinge on the etched surface depends on the potential distribution. In addition, plasma potential determines the energy with which ions strike other surfaces in the chamber, and high-energy bombardment of these surfaces can cause sputtering and consequent redeposition of the sputtered material. Silicon-based residues are often formed on the interior surfaces of a processing operation, such as in deposition and etching operations involving silicon wafers. In addition, carbon based residues can also be formed on the interior surfaces when etching wafers with photoresist, or when using carbon-containing gas in the substrate processing step (e.g., CH₄, CH₂F₂, CHF₃).

The wafer-less auto clean (WAC) of the present invention efficiently cleans these deposits and allows for a consistent baseline environment for the beginning of each etch operation. In one embodiment, a two step WAC begins by forming a first plasma from process etchant gases introduced into the processing chamber. The first plasma is optimized to react with the silicon-based residues to form gases that may be removed from the chamber's interior. Following the first plasma process, a second plasma is formed from process etchant gases introduced into the processing chamber. The second plasma is optimized to react with the carbon-based residues to form gases that may be removed from the chamber's interior.

Because silicon residues are more prevalent in the chamber, the two step method can be configured to spend more time to ensure removal of the silicon based byproducts and less time so that the carbon based byproducts are removed without over-cleaning. Thus, the two step process will not have a significant impact on the throughput of the system as compared to a composite one step process. Additionally, the optimized two step process provides for a more uniform environment inside the processing chamber between each operation. Consequently, the repeatability of the etch operation from wafer to wafer is enhanced because of the consistent environment provided inside the processing chamber through the two step WAC technique. That is, the build-up of byproducts on the inner surfaces of the processing chamber, over time, is substantially eliminated allowing for stable/repeatable etch rates from wafer to wafer and extended mean time between cleaning (MTBC).

It should be appreciated that the present invention can also be employed with a single step WAC. For example, where carbon based byproducts are not an issue, a single step WAC can be run under the high pressure regime to substantially eliminate AlFₓ residue left by the WAC process. Alternatively, a single step WAC process having a composite gas mixture with species directed toward both silicon based byproducts and carbon based byproducts can be operated in the high pressure regime to lower the ion energy to cross a threshold level where the aluminum or ceramic chamber is not attacked.

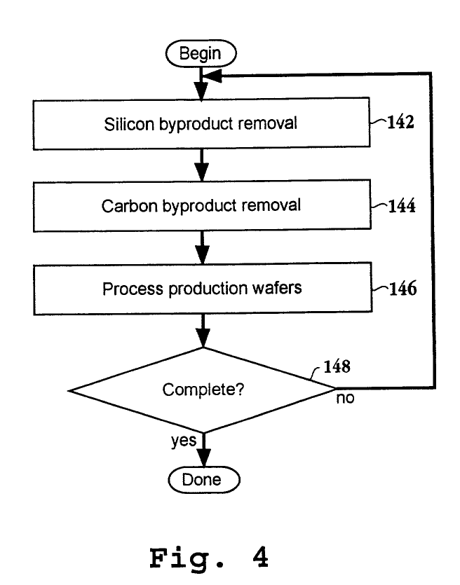

FIG. 3 is a simplified cross-sectional schematic diagram of a plasma etching system configured to execute a dual step cleaning process in accordance with one embodiment of the invention. Exemplary plasma etch systems include the 2300 VERSYS™ Silicon Wafer-less Auto Clean System, also referred to as PolyWAC, and the TCP® 9400PTX, both owned by the assignee. Plasma etching system 100 consists of several components, such as etching chamber 102, a pumping system 104 for evacuating the etching chamber in between process operations, pressure gauges 106 to monitor pressure in the chamber, a variable conductance meter 108 between pumping system 104 and etching chamber 102 so that the pressure and flow rate in the etching chamber can be controlled independently. A radio frequency (RF) power supply 110 creates plasma 105 through RF coils 103. Gas handler 112 meters and controls the flow of reactant gases. Optical emission spectroscopy (OES) monitor 116 monitors wavelengths specific to etching chamber 102 deposition removal products and chamber deposition removal reactants. It should be appreciated that in the past plasma cleans were used for cleaning reactors with the wafer in the reactor chamber to cover the electrode, but it has become more common to do wafer-less plasma cleans. This has led to the use of a wafer-less auto clean (WAC). In one embodiment, the operations are computer controlled to automatically start the wafer-less plasma cleans at set wafer processing intervals. For example, the WAC process can be run after each wafer, after a lot of wafers or after some other suitable interval. In another embodiment, the process parameters discussed below are input as a recipe and the process parameters are controlled by a control system, such as a programmable logic controller that interfaces with the reaction chamber.

The WAC process has conventionally used a composite one-step recipe focused on the removal of all chamber deposition byproducts involving a mixture of etchant gases for the removal of both silicon based byproducts and carbon based byproducts. However, a composite WAC recipe for both silicon and carbon byproduct removal suffers from lower removal rates of both silicon and carbon-based deposition byproducts. As mentioned above, aluminum fluoride compounds left by either the one step or two step WAC processes, in which fluorine based etchant is used, will adversely impact etching operations over time.

As is known in the art, silicon-based residues are often formed on the interior surfaces of a processing operation, such as in deposition and etching operations involving silicon wafers. Carbon based deposition products are also formed on the chamber during processing operations. In general, the percentage of silicon based byproducts to carbon based byproducts is not a 1:1 ratio, since silicon based byproducts are found in a greater amount than carbon based byproducts. It will be apparent to one skilled in the art that silicon based byproducts are the predominant chamber deposition species in Polysilicon Etch equipment.

The present invention provides a method to clean the inner surfaces of semiconductor processing chamber by forming a plasma from process etchant gases specific and optimized to the byproduct to be removed wherein the cleaning method does not leave a deposit or residue. That is, the cleaning process for the silicon based byproducts is optimized to efficiently remove silicon based byproducts, while the cleaning process for the carbon based byproducts is optimized to efficiently remove carbon based byproducts. Furthermore, the cleaning process for the silicon based byproduct, which uses a fluorine based etchant, is executed at an elevated pressure in order to substantially eliminate any AlFₓ deposits. In one embodiment, the targeted byproduct removal process is a two step process where the first step uses SF₆ chemistry, or other fluorine based chemistry, such as NF₃ or CF₄, to remove silicon-based byproducts. The second step uses oxygen (O₂) based chemistry to remove carbon based byproducts from the chamber walls. The cleaning process is preferably performed after each wafer, however, any suitable cleaning frequency may be used.

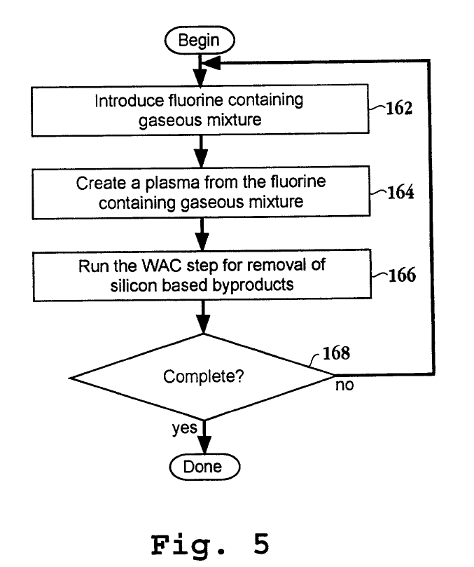

FIG. 4 is a flowchart diagram of the method operations performed for a dual step byproduct removal WAC technique in accordance with one embodiment of the invention. The method initiates with operation 142 where silicon byproduct is removed. It should be appreciated that operation 142 can be performed following the processing of a wafer or multiple wafers. Here, a fluorine based etchant gas is introduced into the chamber and a plasma is struck. The fluorine based plasma removes the silicon based) byproducts from the inner surfaces of the processing chamber. The method then moves to operation 144 where a carbon based byproduct is removed. Here, an oxygen based (O₂) based etchant gas is introduced into the chamber and a plasma is struck. It should be appreciated that the decoupling of the two process steps allows for each process to be optimized for the particular byproduct. As mentioned above, when silicon is the predominant chamber deposition species the time for each process step can be optimized. More specifically, the time for the silicon cleaning step can be lengthened while the time for the carbon cleaning step can be shortened. Thus, the cleaning time does not substantially increase from the cleaning time for the composite WAC process. It should be appreciated that the operations can be performed for a specified amount of time or the cleaning operations can be controlled through software detection of an endpoint.

The method then advances to operation 146 where the production wafers are processed in the chamber. As mentioned above, multiple wafers may be processed in between cleaning operations or a single wafer may be processed in between cleaning operations. The processing performed on the production wafers could be any etch or deposition process, such as Polygate, shallow trench isolation (STI) applications and other suitable semiconductor processing operations that can deposit material on the inner surfaces of the processing chamber. The method then proceeds to decision operation 148 where it is determined if the processing for the wafer is completed. If the processing is not complete, then the method returns to operation 142. The process is repeated until all the wafers have been completed. If it is determined that the processing is complete then the method terminates.

FIG. 5 is a more detailed flowchart diagram of the method operation of removal of silicon byproduct of FIG. 4. The method initiates with operation 162 where a fluorine containing gaseous mixture is introduced into a processing chamber. A suitable processing chamber is the chamber described with reference to FIG. 3. Fluorine is used as an etchant for the removal of silicon based compounds. In one embodiment, the fluorine etchant is a gaseous composition that includes at least about 60% of a fluorine-containing compound of the formula X_{y}F_{z} and is introduced into a reaction chamber configured to support a wafer-less auto clean (WAC) process, such as the processing chamber of FIG. 3. The recipe for removing the silicon byproduct with the fluorine etchant is optimized for process parameters such as: pressure, reactant gas flow rate, transformer coupled plasma power and bias voltage for maximum removal of silicon and silicon based compounds from interior surfaces of the processing chamber. Table 1 below provides process operating ranges for process parameters configured for the TCP 9400 plasma etcher of the assignee in accordance with one embodiment of the invention. Furthermore, the ranges of Table 1 are optimal ranges for a plasma etch system, such as the TCP 9400 PTX etch system. One skilled in the art will appreciate that the ranges may be scaled according to the size of the chamber for different etch systems. As shown below, the flow rate of the fluorine containing gaseous mixture, i.e., SF₆, of operation 162 can range from about 50 standard cubic centimeters per minute (sccm) to about 1000 sccm in one embodiment of the invention. A preferred range for the flow rate of SF₆ is between about 100 sccm and about 500 sccm.

TABLE 1

| Parameter | Optimal Range | Mid Range | Wide Range |
|---|---|---|---|
| Pressure | 85 mT | >50 mT | >40 mT |
| TCP Power | 800 W | 500-1000 W | 500-1500 W |
| SF₆ Flow | 100-500 sccm | 100-700 sccm | 50-1000 sccm |
| Chamber Temperature | 60° C. | 40° C.-80° C. | 20° C.-100° C. |

The method then advances to operation 164 where a plasma is created from the fluorine containing gaseous mixture. The processing parameters are provided with reference to Table 1. In particular, the pressure can be greater than 40 mT, with a preferred range of about 85 mT. It should be appreciated that the provided ranges may vary with the different configurations of processing chamber. For example, the preferred pressure for the 2300 VERSYS® system is about 65 mT due to the different geometric configuration of the processing chamber as compared to the 9400 system, where the optimal pressure for reducing the ion energy so that aluminum fluoride compounds are substantially eliminated is about 85 mT. The transformer coupled plasma (TCP) power is between about 500 watts (W) and about 1500 W, with a preferred range of about 800 W. One skilled in the art will appreciate that the processing chamber may be configured as a capacitively coupled chamber, an inductively coupled chamber, or a wave-excited plasma chamber. Additionally, the fluorine containing gas can include a mixture of SF₆ and NF₃. In one embodiment, the mixture is a 1:1 ratio of the SF₆ and NF₃ gases. Alternatively, the NF₃, CF₄, and C₂F₆ can replace the SF₆. In another embodiment, the gas mixture may contain a small percentage of O₂. Here, the O₂ flow rate would be between about 0 and about 40 sccm.

The method of FIG. 5 then proceeds to operation 166 where the WAC step for removal of silicon based byproducts is performed. Here, the silicon clean step, as explained above, is executed with the process parameters set as described above with reference to Table 1. Due to the elevated pressure the fluorine based plasma does not attack the aluminum based surfaces of the processing chamber. Therefore, an AlFₓ residue is not left behind by the silicon clean step. The method then advances to decision operation 168 where it is determined if the silicon byproduct has been removed. In one embodiment, the endpoint is determined by optical emission spectroscopy (OES), such as through OES monitor 116 with reference to FIG. 3.

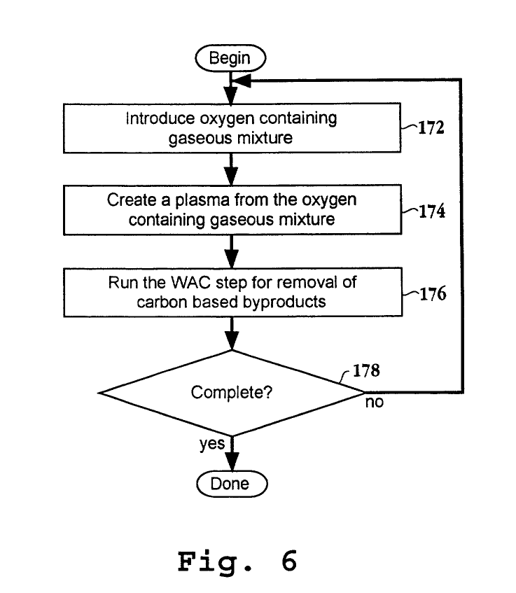

FIG. 6 is a more detailed flowchart diagram of the method operation of removal of carbon byproducts of FIG. 4. The method initiates with operation 172 where an oxygen (O₂) containing gaseous mixture is introduced to a semiconductor processing chamber. It should be appreciated that the O₂ flow may or may not contain a small percentage of a fluorine containing gas, such as the fluorine containing gas etchants mentioned above with reference to FIG. 5. The recipe for removing the carbon byproduct with the oxygen etchant is optimized for process parameters such as: pressure, reactant gas flow rate, TCP power and bias voltage for maximum removal of carbon and carbon based compounds from interior surfaces of the processing chamber. Table 2 below provides process operating ranges for process parameters for a carbon clean where a small amount of a fluorine containing gas is optional in accordance with one embodiment of the invention. It should be appreciated that the provided ranges may vary with the different configurations of the processing chamber as discussed above. Furthermore, the ranges of Table 2 are optimal ranges for a plasma etch system, such as the 9400 system mentioned above. As shown below, the flow rate of the oxygen containing gaseous mixture of operation 172 can range from about 50 standard cubic centimeters per minute (sccm) to about 1000 sccm with a preferred oxygen flow rate of about 50 sccm.

TABLE 2

| Parameter | Optimal Range | Mid Range | Wide Range |
|---|---|---|---|
| Pressure | 20 mT | 10-30 mT | 0-40 mT |
| TCP Power | 800 W | 500-1000 W | 500-1500 W |
| O₂ Flow | 50 sccm | 50-500 sccm | 50-1000 sccm |
| SF₆ Flow (10% of O₂ | 5 sccm | 5-50 sccm | 0-100 sccm |
| Flow Max.) | | | |
| Chamber Temperature | 60° C. | 40° C.-80° C. | 20° C.-100° C. |

The method of FIG. 6 then advances to operation 174 where a plasma is created from the oxygen containing gaseous mixture. The processing parameters are provided with reference to Table 2. In particular, the pressure can be between 0 mT and 40 mT, with an optimal range of about 20 mT. It should be appreciated that the provided ranges may vary with the different geometric configurations of the processing chamber. The transformer coupled plasma (TCP) power is between about 500 watts (W) and about 1500 W. One skilled in the art will appreciate that the processing chamber may be configured as a capacitively coupled chamber, inductively coupled chamber, or a wave-exited plasma chamber. The fluorine containing gas can be introduced at a flow rate of between about 0% and about 10% of the maximum flow rate of the oxygen containing gas. It will be apparent to one skilled in the art that while SF₆ is listed as the fluorine containing gas, other fluorine containing gases, such as NF₃ can be substituted. In one embodiment, the oxygen containing gas is introduced with an inert gas into the processing chamber. For example, the oxygen containing gas can be mixed with nitrogen, argon, helium, etc. In this embodiment, the inert gas flow rate is between about 0% and 20% of the maximum flow rate of the oxygen containing gas. The chamber temperature can range anywhere between about 20° C. and about 100° C.

The method of FIG. 6 then proceeds to operation 176 where the WAC step for the removal of carbon based byproducts is performed. Here, the carbon clean step, as explained above, is executed with the process parameters set as described with reference to Table 2 or Table 3. In decision operation 178 it is determined if the carbon byproduct has been removed. In one embodiment, the endpoint is determined by optical emission spectroscopy (OES), such as through OES monitor 116 with reference to FIG. 3.

As the addition of a fluorine containing gas is optional during the carbon clean step, Table 3 lists the process parameters for a carbon clean step in which only an oxygen containing gas is used to create a plasma, in accordance with one embodiment of the invention. It should be appreciated that the ranges provided in Table 3 are substantially similar to the ranges provided in Table 2 above, except that Table 3 eliminates the fluorine containing gas. One skilled in the art will appreciate that the carbon clean step is run at a low pressure as fluorine is either not used in the carbon clean step or only a negligible amount of fluorine is used.

TABLE 3

| Parameter | Optimal Range | Mid Range | Wide Range |
|---|---|---|---|
| Pressure | 20 mT | 10-30 mT | 0-40 mT |
| TCP Power | 1000 W | 500-1000 W | 500-1500 W |
| O₂ Flow | 50 sccm | 50-500 sccm | 50-1000 sccm |
| Chamber Temperature | 60° C. | 40° C.-80° C. | 20° C.-100° C. |

It is preferred to perform the two step process with the silicon clean step performed first and the carbon clean step performed second. However, the order of the steps can be reversed.

As discussed above, the endpoints for the silicon clean step and the carbon clean step can employ optical emission spectroscopy (OES) to monitor wavelengths specific to chamber deposition removal products and chamber deposition removal reactants. The specific wavelengths monitored are fluorine emission lines at 685 nm and 703 nm. These lines are used for determining endpoint of silicon-containing species. The intensity of the specific wavelengths is noted for slope as a function of time. When intensity curves for the specific wavelengths shows about a zero slope, it is indicative of no additional cleaning occurring and no change in the relative concentration of the reactant or product species. In one embodiment, the WAC endpoint time for the silicon based byproduct is reached when the recommended wavelengths (685 nm or 703 nm) produce the initial clean chamber intensities and intensity curve slope of about zero with time.

The specific wavelength for monitoring the cleaning of carbon-containing compounds is 516 nm. Therefore, the WAC endpoint time for the carbon based compounds will be reached when the 516 nm wavelength produces the initial clean chamber intensities and intensity curve slope of about zero with time. It should be appreciated that when fluorine containing compounds are included in the carbon clean, then all the above listed wavelengths can be monitored to determine an endpoint.

Table 4 summarizes the two step WAC recipe in accordance with one embodiment of the invention. As mentioned above, the endpoint times for the silicon clean times and the carbon clean times can be determined based upon a signal detected by an OES monitor. The OES monitor is configured to detect the appropriate wavelengths, as described above, and the signals are then compared to a baseline signal of a clean chamber state.

TABLE 4

| Step Number | 1 | 2 | 3 |
|---|---|---|---|
| Step Type | Stability | Silicon Clean-1 | Carbon Clean-2 |
| Pressure | 85 mT | 85 mT | 10 mT |
| TCP Power | 0 | 800 W | 800 W |
| Bias Voltage | 0 | 0 | 0 |
| O₂ | 20 | 20 | 50 sccm |
| SF₆ | 100-200 sccm | 100-200 sccm | 0 sccm |
| Inert gas (e.g., Ar) | 10 sccm | 10 sccm | 10 sccm |
| Completion basis | Stable | Time | Time |
| Time (sec) | 30 | 10-30 | 5-35 |

One skilled in the art will appreciate that the stability step conditions the environment inside the chamber so the environment is stable and consistent prior to starting the silicon clean step. As mentioned above the carbon clean step can be performed with an oxygen containing compound only or with an oxygen containing compound and a fluorine containing compound. Additionally, an inert gas can be introduced with an oxygen containing compound in step number 3. Table 4 is shown for exemplary purposes only and not meant to be limiting. In addition to the process parameters varying between processing chamber designs, values for the parameters within the ranges provided in Tables 1-3 can also be substituted.

As shown by Table 4, the time allotted for the silicon clean step and the carbon clean step can be tailored to the type of process. That is, if the process deposits more silicon based byproducts on the chamber walls, then the silicon clean step is configured to remove the deposited byproducts without over-cleaning or under-cleaning. In turn, a more consistent environment is provided for substantially eliminating etch rate drift due to varying chamber conditioning. Furthermore, the high pressure regime substantially eliminates any AlFₓ residue left by the WAC process. While Table 4 provides specific times for each step, each of the steps can be controlled through the detection of an endpoint by an OES monitor configured to detect certain wavelengths. Here, the OES monitor would detect the endpoint and output a signal to trigger the completion of the respective cleaning step.

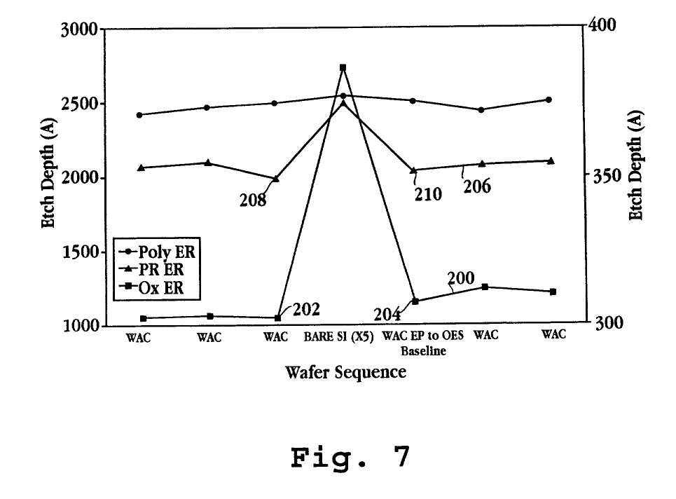

FIG. 7 is a graph depicting the effect of the WAC process on the etch rate performance in accordance with one embodiment of the invention. It is known that initial etch rates are lower from a clean chamber until a sufficient number of conditioning wafers are employed to stabilize the etch rate which in turn slowly drifts over the course of the mean time between cleaning (MTBC) cycles, i.e., wet cleaning. Line 200 represents an oxide etch rate where a WAC is performed at different time periods. A wafer-less auto clean is performed after each wafer up to point 202. Then, 5 bare silicon wafers are processed after point 202 without performing a WAC. As shown, there is approximately a 27% increase in the oxide etch rate on a pattern oxide wafer without a WAC vs. with a WAC after every wafer. That is, the wafer etched following the 5 bare wafers performed without a WAC, experiences a 27% increase in etch depth. It should be appreciated that at point 204, the WAC is resumed after every wafer.

Still referring to FIG. 7, the photoresist (PR) etch rate, represented by line 206, is similarly impacted when compared with and without WAC performed after every wafer being processed. That is, between point 208 and 210, where 5 bare silicon wafers are processed, there is approximately a 25% increase in the PR etch rate. Likewise, once the WAC is resumed at point 210 the etch rate stabilizes from wafer to wafer. Accordingly, performing the WAC after every cycle provides a constant starting point for each etch operation, thereby enabling minimal variation of the etch rate from wafer to wafer. It should be appreciated that the WAC allows for the repeatability of the etch rate, within a narrow range, for each successive etch operation.

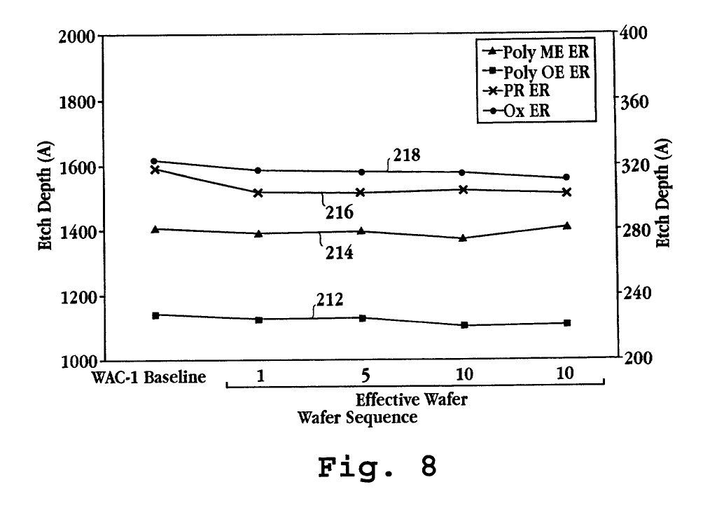

FIG. 8 is a graph of etch rate repeatability using a Polygate Release recipe where a WAC is performed after each wafer in accordance with one embodiment of the invention. Lines 212, 214, 216 and 218 represent poly main etch, poly over etch, oxide main etch and photoresist main etch, respectively. The etch rate repeatability and stability from the first wafer to the 25^{th} wafer was measured when a WAC was performed initially and after each wafer was processed. The etch rate repeatability and stability over the 25 wafers with a WAC performed between each wafer was within 0.7% for the poly main etch, 2.6% for the poly over etch, 3.1% for the oxide main etch and 4.6% for the photoresist main etch. Accordingly, by providing a consistent environment from wafer to wafer, along with standardizing the starting conditions through the performance of a WAC that is designed for optimization of each of the silicon and carbon byproducts, tighter control over the etch rates is accomplished. In turn, the critical dimensions defined through the etching processes are controlled within suitable ranges.

FIG. 9 is a graph comparing silicon based byproducts present on the chamber inner surfaces before and after a high pressure WAC process is performed in accordance with one embodiment of the invention. The effectiveness of the wall cleaning was monitored by attenuated total internal reflection Fourier transform infrared (ATIR-FTIR) spectroscopy. It will be apparent to one skilled in the art that ATIR-FTIR is used to detect deposition on a zinc selenium (ZnSe) crystal located on the chamber wall. The deposition of the etch byproducts appears in the ATIR-FTIR signal as absorbance of the infrared (IR) beam as silicon oxide (Si-O) stretches (1020-1270 cm⁻¹ wavenumbers) as shown in FIG. 9. Line 240 represents a trace of the ATIR-FTIR signal of the chamber inner surfaces prior to the WAC process. Thus, a large silicon oxide peak indicates the silicon based byproduct deposited on the chamber surfaces. After running a high pressure WAC on the chamber, line 242 illustrates that the silicon based byproduct has been removed from the inner surfaces of the chamber.

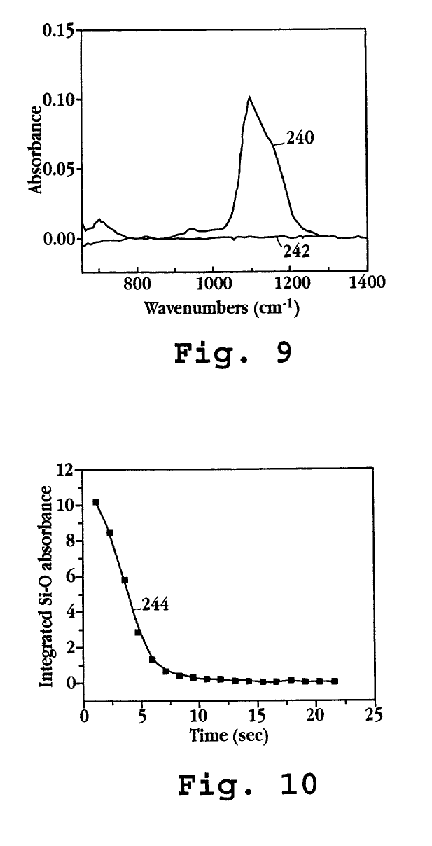

FIG. 10 is a graph of the area under the Si-O peak of FIG. 9 as a function of the high pressure WAC time in accordance with one embodiment of the invention. A suitable high pressure WAC includes the silicon clean step of the WAC process discussed above with reference to Tables 1-4. The high pressure WAC cleans the silicon containing deposits on the wall in less than 15 seconds as detected by the decrease in the Si-O absorbance signal represented by line 244.

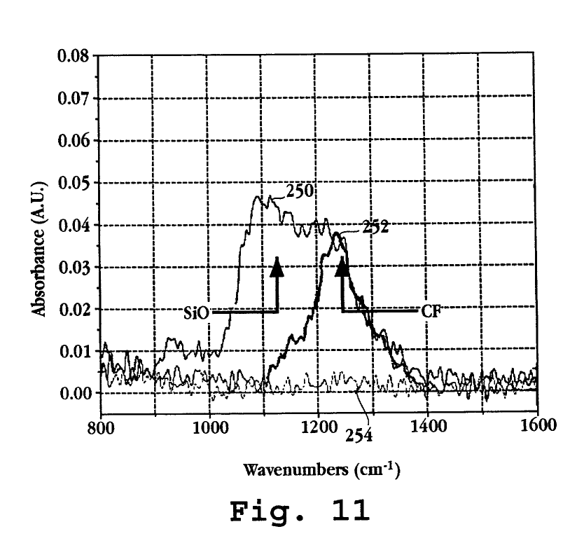

FIG. 11 is a graph of comparing silicon based byproducts and carbon based byproducts before and after a two step high pressure WAC process is performed in accordance with one embodiment of the invention. Line 250 represents a trace of the ATIR-FTIR signal of the chamber inner surfaces prior to the WAC process after an in-situ open mask shallow trench isolation process. Line 252 represents a trace of the ATIR-FTIR signal of the chamber inner surfaces after a silicon clean step of a two step WAC was performed. Here, silicon clean step was run at 85 mT with SF₆/O₂ cleaning chemistry for 16 seconds. The remaining process parameters can be defined as detailed with reference to Table 1. The silicon clean step at high pressure removes the silicon based byproducts on the chamber walls without leaving any aluminum fluoride behind. However, carbon based byproducts are not removed from the chamber walls as shown by the area under line 252. Thus, after running a carbon clean step and monitoring the chamber through the ATIR-FTIR discussed above with respect to FIG. 9, the trace yields line 254, which demonstrates the removal of both silicon based byproducts and carbon based byproducts. The carbon clean step was run at 20 mT with oxygen (O₂) cleaning chemistry for 30 seconds. The remaining process parameters can be defined as detailed with reference to Tables 2 and 3.

In summary, the high pressure WAC process described herein allows for the substantial elimination of aluminum sputtering caused by the WAC. It should be appreciated that a single step or multiple step WAC can be applied in the high pressure regime. The high pressure regime modulates the ion energy such that a threshold is crossed. The threshold represents an ion energy sufficient for cleaning deposition products from the chamber walls, however, the ion energy below the threshold is not sufficient for sputtering aluminum, i.e., causing an AlFₓ residue from the WAC. Thus, the mean time between wet cleans is increased through the substantial elimination of the AlFₓ particle dust observed when running WAC processes in the low pressure regime. Accordingly, the system throughput is increased as a result of increasing the mean time between wet cleans. Moreover, the yield is likewise improved, especially for 0.18 micrometer technology node and below, since AlFₓ can cause severe particle contamination on a semiconductor substrate.

In addition, a consistent environment in the processing chamber is maintained from wafer to wafer. In turn, the starting process and environmental conditions are substantially the same for each wafer being processed when a high pressure WAC is performed after each processing operation performed in the processing chamber. The consistent environment allow for the repeatability and reproducibility of the processing operations with minimal wafer to wafer variation. Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

What is claimed:

1. A method for cleaning a processing chamber comprising:
introducing a fluorine containing gaseous mixture into a processing chamber;
creating a plasma from the fluorine containing gaseous mixture in the processing chamber; and
establishing a chamber pressure corresponding to a threshold ion energy in which ions of the plasma clean inner surfaces of the processing chamber without leaving a residue.

2. The method of claim 1 wherein the method operation of establishing a chamber pressure corresponding to a threshold ion energy in which ions of the plasma clean inner surfaces of the processing chamber without leaving a residue further includes:
setting the chamber pressure at a minimum of 50 milliTorr; and
removing silicon based byproducts from the inner surfaces of the processing chamber.

3. The method of claim 1, wherein the fluorine containing gaseous mixture is selected from the group consisting of SF₆, NF₃, CF₄, and C₂F₆.

4. The method of claim 2 further including:
evacuating the fluorine containing gaseous mixture from the processing chamber upon removal of the silicon based byproducts;
introducing an oxygen containing gaseous mixture into the processing chamber upon the removal of the fluorine containing gaseous mixture; and
creating a plasma from the oxygen containing gaseous mixture in the processing chamber.

5. The method of claim 1, wherein the chamber pressure is about 85 mTorr.

6. The method of claim 5 further including:
defining process parameters including a temperature of the processing chamber, a power applied to a transformer coupled plasma (TCP) coil, and a flow rate of the fluorine containing gaseous mixture.

7. The method of claim 6, wherein the temperature is about 60° C., the power is about 800 watts, and the flow rate is between about 100 and about 500 standard cubic centimeters per minute (sccm).

8. The method of claim 1 further including:
determining an endpoint to the cleaning process based upon an emission intensity selected from the group consisting of chamber deposition removal products and chamber deposition removal reactants.

9. The method of claim 8, wherein the method operation of determining an endpoint to the cleaning process further includes:
monitoring at least one wavelength selected from the group consisting of 685 nanometers (nm), 703 nm, and 516 nm.

10. A method for substantially eliminating residual aluminum fluoride particles deposited by an in-situ cleaning process for a semiconductor processing chamber formed, at least in part, from aluminum, the method comprising:
performing a processing operation on a semiconductor substrate disposed within a semiconductor processing chamber; and
initiating an in-situ cleaning process upon completion of the processing operation and removal of the semiconductor substrate, the initiating including:
flowing a fluorine containing gas into the processing chamber; and
establishing a pressure within the processing chamber capable of allowing a plasma created from the fluorine containing gas to clean silicon byproducts deposited on an inner surface of the processing chamber without sputtering any aluminum containing parts of the processing chamber.

11. The method of claim 10, wherein the method operation of initiating an in-situ cleaning process upon completion of the processing operation and removal of the semiconductor substrate further includes;
flowing an oxygen containing gas into the processing chamber upon removal of the silicon byproducts while maintaining the pressure; and
creating a plasma from the oxygen containing gas to remove carbon based byproducts deposited on the inner surface of the processing chamber.

12. The method of claim 10, wherein the fluorine containing gas is selected from the group consisting of SF₆, NF₃, CF₄, and C₂F₆.

13. The method of claim 10, wherein the pressure is between about 60 milliTorr (mT) and about 90 mT.

14. The method of claim 10, wherein the fluorine containing gas includes oxygen for removal of carbon based byproducts.

15. The method of claim 10, wherein the processing operation is selected from the group consisting of a polysilicon etch and a crystaline silicon etch.

16. The method of claim 10 further including:
defining process parameters including a temperature of the processing chamber, a power applied to a transformer coupled plasma (TCP) coil, and a flow rate of the fluorine containing gaseous mixture.

17. The method of claim 16, wherein the temperature is about 60° C., the power is about 800 watts, and the flow rate is between about 100 and about 500 standard cubic centimeters per minute (sccm).

18. A plasma processing system for executing an in-situ cleaning process, comprising:
an aluminum based processing chamber configured to operate at an elevated pressure during an in-situ cleaning operation to substantially eliminate the formation of aluminum fluoride during the in-situ cleaning process, the processing chamber including:
a gas inlet for introducing a fluorine containing cleaning gas, the fluorine containing cleaning gas optimized to remove silicon based byproducts deposited on inner surfaces of the processing chamber, and
a radio frequency (RF) coil for creating a plasma from the fluorine containing cleaning gas to perform an in-situ cleaning process;
a variable conductance meter configured to control a pressure inside the processing chamber independently of a flow rate of process gases, the variable conductance meter positioned on an outlet of the processing chamber;
an optical emission spectrometer (OES) for detecting an endpoint for each step of the in-situ cleaning process performed in the processing chamber, the OES in communication with the processing chamber; and
a pumping system for evacuating the processing chamber between each step of the two step cleaning process.

19. The plasma processing system of claim 18, wherein the fluorine containing cleaning gas is selected from the group consisting of SF₆, NF₃, CF₄, and C₂F₆.

20. The plasma processing system of claim 18, wherein the processing chamber is an aluminum ceramic chamber.

21. The plasma processing system of claim 18, wherein the OES monitor is configured to detect wavelengths corresponding to the silicon based byproducts.
